(19) United States
(12) Patent Application Publication
(10) Pub. No.: US 2023/0024680 A1
(43) Pub. Date: Jan. 26, 2023

(54) METHOD OF DETERMINING REGIONAL LAND USAGE PROPERTY, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Xinjiang LU, Beijing (CN); Dejing DOU, Beijing (CN)

(73) Assignee: BEIJING BAIDU NETCOM SCIENCE TECHNOLOGY CO., LTD., Beijing (CN)

(21) Appl. No.: 17/957,275

(22) Filed: Sep. 30, 2022

(30) Foreign Application Priority Data
Sep. 30, 2021 (CN) 202111160570.3

(51) Int. Cl. G06N 3/08; G06Q 50/26

(52) U.S. Cl. CPC G06N 3/08; G06Q 50/26

(57) ABSTRACT

A method of determining a regional land usage property, an electronic device and a storage medium, which relate to a field of an information technology, in particular to a field of a deep learning. The method includes: acquiring a human interaction information between a plurality of regions at a specified time; updating an initial representation vector of each of the regions according to the human interaction information, so as to obtain an embedding representation vector of each of the regions; selecting a target region from the regions, and selecting a plurality of static neighbor regions within a preset range around the target region; generating a feature map of the target region according to the embedding representation vector of the target region and the embedding representation vectors of the plurality of static neighbor regions; and predicting a land usage property of the target region by using the feature map.

This application claims priority to Chinese Patent Application No. 202111160570.3 filed on Sep. 30, 2021, the whole disclosure of which is incorporated herein by reference.

### TECHNICAL FIELD

The present disclosure relates to a field of an information technology, in particular to a field of a deep learning technology.

### BACKGROUND

At present, common land usage properties may include a commercial land, a business land, a residential land, a land for roads and transportation facilities, a land for public facilities, a land for green space and square, etc. With an acceleration of urbanization and industrialization, an appearance of city is changing with each passing day, and a land usage property of a sub-region also tends to change.

Because different land usage properties correspond to different supporting facilities and road planning, how to predict a regional land usage property plays an important role in urban planning and other fields.

### SUMMARY

The present disclosure provides a method of determining a regional land usage property, an electronic device, and a storage medium.

According to an aspect of the present disclosure, there is provided a method of determining a regional land usage property, including: acquiring a human interaction information between a plurality of regions at a specified time; updating an initial representation vector of each of the regions according to the human interaction information, so as to obtain an embedding representation vector of each of the regions, wherein for each region, the initial representation vector of the region is calculated according to an initial land usage property of the region; selecting a target region from the regions, and selecting a plurality of static neighbor regions within a preset range around the target region; generating a feature map of the target region according to the embedding representation vector of the target region and the embedding representation vectors of the plurality of static neighbor regions; and predicting a land usage property of the target region by using the feature map, so as to obtain a predicted land usage property of the target region at a next time.

According to another aspect of the present disclosure, there is further provided an electronic device, including: at least one processor; and a memory communicatively connected to the at least one processor, wherein the memory stores instructions executable by the at least one processor, and the instructions, when executed by the at least one processor, cause the at least one processor to perform the method of determining the regional land usage property described above.

According to another aspect of the present disclosure, there is further provided a non-transitory computer-readable storage medium having computer instructions stored thereon, wherein the computer instructions allow a computer to perform the method of determining the regional land usage property described above.

The method of determining the regional land usage property, the electronic device and the storage medium in the present disclosure may be implemented to: acquire a human interaction information between a plurality of regions at a specified time; update an initial representation vector of each of the regions according to the human interaction information, so as to obtain an embedding representation vector of each of the regions, wherein for any region, the initial representation vector of the region is calculated according to an initial land usage property of the region; select a target region from the regions, and select a plurality of static neighbor regions within a preset range around the target region; generate a feature map of the target region according to the embedding representation vector of the target region and the embedding representation vectors of the plurality of static neighbor regions; and predict a land usage property of the target region by using the feature map, so as to obtain a predicted land usage property of the target region at a next time.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the present solution and do not constitute a limitation to the present disclosure.

FIG. 1 shows a schematic diagram according to a first embodiment of the present disclosure.

FIG. 2 shows a schematic diagram according to a second embodiment of the present disclosure.

FIG. 3 shows a schematic diagram according to a fourth embodiment of the present disclosure.

FIG. 4 shows a schematic diagram according to a fifth embodiment of the present disclosure.

FIG. 5 shows a schematic diagram according to a sixth embodiment of the present disclosure.

FIG. 6 shows a schematic diagram according to a seventh embodiment of the present disclosure.

FIG. 7 shows a schematic diagram according to a ninth embodiment of the present disclosure.

FIG. 8 shows a schematic diagram according to a tenth embodiment of the present disclosure.

FIG. 9 shows a schematic diagram according to a thirteenth embodiment of the present disclosure.

FIG. 10 shows a schematic diagram according to a fourteenth embodiment of the present disclosure.

FIG. 11 shows a block diagram of an electronic device for implementing the method of determining the regional land usage property according to the embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

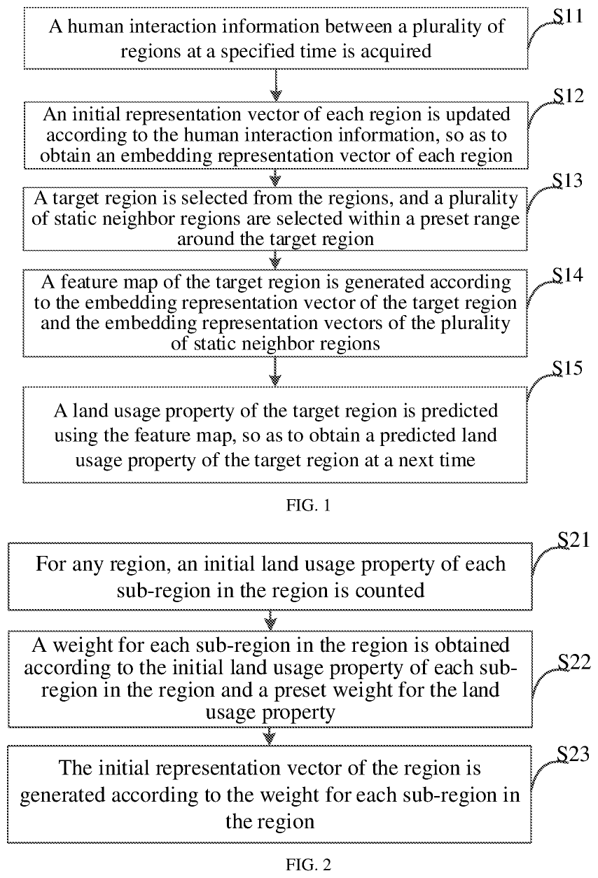

According to an aspect of the present disclosure, there is provided a method of determining a regional land usage property. As shown in FIG. 1, the method includes step S11 to step S15.

In step S11, a human interaction information between a plurality of regions at a specified time is acquired.

The region in the present disclosure may refer to a block. In a practical use, the block may be a region enclosed by multiple roads, such as a common square region enclosed by four roads or a triangular region enclosed by three roads. A human interaction may refer to a flow of human between regions or a mutual retrieval between regions. For example, a human in region A is going to region B, or a human in region A is retrieving an information of region B. When the human interaction refers to the flow of human between the regions, the human interaction information is a flow frequency of moving human. For example, at time t, 13 humans in region A are going to region B, then a flow frequency 13 may be used as the human interaction information. When the human interaction is the mutual retrieval between the regions, the human interaction information is a frequency of the mutual retrieval between the regions. For example, at time t, 10 humans in region A are retrieving an environment of region B, 8 humans in region A are retrieving fine food of region B, and 6 humans in region A are retrieving an educational information of region B, then a total number of retrievals 24 may be used as the human interaction information.

In the present disclosure, a dynamic neighbor region of each region may be set according to the human interaction information between the plurality of regions at the specified time. For each region, the dynamic neighbor region of the region is a region having a human interaction with the region. For example, at time t, if a human from region A is going to region B, region A may be determined as the dynamic neighbor region of region B. For another example, at time t, if a human in region A is retrieving a relevant information of region B, region A may be determined as the dynamic neighbor region of region B.

The method of the present disclosure is applied to an intelligent terminal with which the regional land usage property may be predicted by using a pre-trained convolution model. Specifically, the intelligent terminal may be a computer, a server, etc.

In step S12, an initial representation vector of each region is updated according to the human interaction information, so as to obtain an embedding representation vector of each region.

For each region, the initial representation vector of the region is a vector calculated according to an initial land usage property of the region. The land usage property in the present disclosure may be used to represent a use attribute of a land in the region. For example, the land usage property may include a commercial land, a business land, a residential land, a land for roads and traffic facilities, a land for green space and square, etc. To calculate the initial representation vector of the region according to the initial land usage property in the region, different weights may be set for different land usage properties, and then the initial representation vector of the region may be calculated according to the weights for the initial land usage properties in the region. For example, weights for commercial land, business land and residential land may be preset to 1.1, 0.7 and 0.3 respectively. Then, the initial representation vector of the region may be calculated according to the initial land usage property of the region. The corresponding weight may be found according to the land usage property of the region in an initial state. Because a region generally includes a plurality of sub-regions with different land usage properties, a corresponding vector may be generated by combining the weights for the land usage properties of the sub-regions.

Optionally, updating the initial representation vector of each region according to the human interaction information so as to obtain the embedding representation vector of each region may include: calculating a fusion feature vector of each region according to the human interaction information and the initial representation vector of each region; performing a weighted summation on the fusion feature vector of each region and the initial representation vector of each region according to a preset coefficient, so as to obtain the embedding representation vector of each region.

Specifically, to calculate the embedding representation vector of each region, the human interaction information of each region and the initial representation vector of each region may be aggregated to obtain an aggregated feature vector, then a weighted summation is performed on the fusion feature vector of each region and the initial representation vector of each region according to the preset coefficient. For example, for a specified region, the embedding representation vector may be calculated by preset Equation (1) and Equation (2).

W̅(̅u̅)̅=Σ_{d∈D}Σ_{v∈N′(u)}ωᵥ^{d(t)}(u)·W(u): (1)

W′(u)=λ₁W(u)+λ₂W̅(̅u̅)̅; (2)

where λ₁ and λ₂ are preset coefficients, which are hyperparameters in the practical use; d represents a dynamic relationship, that is, a human interaction relationship between two regions; D is a set of dynamic relationships; W(u) represents an initial representation vector of a specified region u; ωᵥ^{d(t)}(u) represents a human interaction information in the specified region at time t; v represents a dynamic neighbor region of the specified region; N′(u) is a set of dynamic neighbor regions of the specified region; W̅(̅u̅)̅ represents an aggregated feature vector; W′(u) represents an embedding representation vector.

By calculating the fusion feature vector of each region using the preset equation according to the human interaction information and the initial representation vector of each region and calculating the embedding representation vector according to the fusion feature vector, the human interaction information with a dynamic feature of the regional land usage property and the initial representation vector with a static feature of the regional land usage property may be merged, so that the regional land usage property may be predicted through the features including the static feature and the dynamic feature, which may improve an accuracy of a prediction result.

In step S13, a target region is selected from the regions, and a plurality of static neighbor regions are selected within a preset range around the target region.

The target region may be a region currently to be predicted for the land usage property. To determine the plurality of static neighbor regions within the preset range around the target region, the regions within a preset distance around the target region with the target region as a center may be selected as the static neighbor regions. Since the distance of the determined neighbor region may not change over time, this type of neighbor region is called a static neighbor region in the present disclosure. For example, all regions within two kilometers around the target region with the target region as a center may be selected as the static neighbor regions. For another example, a region adjacent to the target region and a region separated from the target region by only one region may be determined as the static neighbor regions.

Optionally, selecting a target region from the regions and selecting a plurality of static neighbor regions within a preset range around the target region may include: selecting a region to be predicted for the land usage property from the regions, so as to obtain the target region; and selecting a plurality of random regions within the preset range around the target region, so as to obtain the plurality of static neighbor regions. For example, the target region may be selected from the regions, and a plurality of random regions may be selected within the preset range around the target region to obtain a plurality of static neighbor regions. For example, a plurality of random regions may be selected as the static neighbor regions from all regions within two kilometers around the target region with the target region as a center. By selecting a candidate neighbor region from the regions, the number of the static neighbor regions to be analyzed may be reduced, so that an analysis speed may be improved.

In step S14, a feature map of the target region is generated according to the embedding representation vector of the target region and the embedding representation vectors of the plurality of static neighbor regions.

To generate the feature map of the target region according to the embedding representation vector of the target region and the embedding representation vectors of the plurality of static neighbor regions, the feature map of the target region may be generated with the target region and each static neighbor region as nodes. Moreover, the feature map may contain the embedding representation vector of the target region and the embedding representation vectors of the plurality of static neighbor regions. For example, the feature map may contain node A corresponding to the target region, node B, node C and node D corresponding to static neighbor regions B, C and D of the region A, and the embedding representation vectors of the nodes.

In step S15, a land usage property of the target region is predicted using the feature map, so as to obtain a predicted land usage property of the target region at a next time.

In an example, predicting a land usage property of the target region using the feature map so as to obtain a predicted land usage property of the target region at a next time may include: analyzing the feature sub-map by using a pre-trained graph convolution network so as to obtain the predicted land usage property of the target block at the next time. The pre-trained graph convolution network is a network model trained using a historical land usage property. To analyze the feature map using the pre-trained graph convolution network so as to obtain the predicted land usage property of the target region at the next time, the graph convolution network may analyze and calculate to obtain a representation vector of the target region at the next time, and then the land usage property corresponding to each value in the representation vector may be found according to the corresponding relationship between the preset land usage properties and weights, so as to obtain the predicted land usage property of the target region at the next time.

The pre-trained graph convolution network is a network model trained using the historical land usage property. Specifically, the graph convolution network may be trained as follows. A land usage property information of a region in a plurality of time periods is acquired. A plurality of sample sub-graphs are generated according to the land usage property information in the plurality of time periods. The plurality of sub-graphs are input into a graph convolution network to be trained, and a land usage property of the region is predicted using the graph convolution network to obtain a prediction result. The obtained prediction result is compared with a pre-acquired true land usage property in a next time period so as to determine whether the prediction result is correct. A current loss of the graph convolution network to be trained is calculated according to a determination result. A model parameter is optimized using a back propagation optimization algorithm according to the calculated loss. The model with the optimized parameter receives the sample sub-graphs again and predicts the land usage property. The graph convolution network is trained well until the calculated loss is less than a preset threshold.

In the method of the embodiments of the present disclosure, the embedding representation vector is set according to the land usage property of the region, then the embedding representation vector of the target region and the embedding representation vectors of the plurality of static neighbor regions are used to generate the feature map, and finally the feature map is used to predict the land usage property of the target region so as to obtain the predicted land usage property of the target region at the next time. The regional land usage property may be predicted, and the predicted regional land usage property may provide reference for urban planning. In this way, not only a speed of prediction may be improved taking advantage of an easy acquisition of static correlation information, but also an accuracy of prediction may be improved by combining a dynamic correlation information with the static correlation information.

Optionally, referring to FIG. 2, before step S12 in which an initial representation vector of each region is updated according to the human interaction information so as to obtain an embedding representation vector of each region, the method further includes step S21 to step S23.

In step S21, for any region, an initial land usage property of each sub-region in the region is counted.

In step S22, a weight for each sub-region in the region is obtained according to the initial land usage property of each sub-region in the region and a preset weight for a land usage property.

In step S23, the initial representation vector of the region is generated according to the weight for each sub-region in the region.

In the practical use, a land in a region may generally be divided into a plurality of sub-regions according to the land usage property. For example, when a region contains a school, a residential area and an office building, each of the school, the residential area and the office building may be divided into a sub-region. Therefore, when counting the initial land usage property of each sub-region in any region, a variety of land usage properties may be counted. Specifically, when counting the initial land usage property of each sub-region in any region, locations of the sub-regions corresponding to different land usage properties may also be contained.

To obtain the weight for each sub-region in any region according to the initial land usage property of each sub-region in the region and the preset weight for the land usage property, different weights may be preset for different land usage properties, and then a corresponding weight may be found according to the initial land usage property in the region. For example, the weights for the commercial land, the business land and the residential land may be preset to 1.1, 0.7 and 0.3 respectively. Accordingly, when the initial land usage properties of the sub-regions in the region include the commercial land, the residential land, the business land and the residential land, the weights of 1.1, 0.3, 0.7 and 0.3 may be obtained respectively for the sub-regions in the region.

To generate the initial representation vector of the region according to the weight for each sub-region in the region, an order may be preset, and the weights for the sub-regions in the region may be selected in this order to generate the initial representation vector. For example, for a region, the land usage properties of the sub-regions in the region in an order from left to right and from top to bottom are respectively residential land, business land, commercial land and residential land, then the sorted weights are respectively 0.3, 0.7, 1.1 and 0.3, and the initial representation vector (0.3, 0.7, 1.1, 0.3) is generated.

With the method of the embodiments of the present disclosure, different weights may be set for the land usage properties in the region, then the initial representation vector of any region may be generated according to the weights, and the land usage property of the region may be predicted according to the land usage properties of the sub-regions in the region, which may improve the accuracy of the prediction result.

Optionally, the human interaction information includes a first interaction information and/or a second interaction information, and acquiring the human interaction information between a plurality of regions at a specified time includes: acquiring a flow frequency of human moving between the plurality of regions at the specified time, and determining the flow frequency as the first interaction information; and/or acquiring a region retrieval frequency of human between the plurality of regions at the specified time, and determining the region retrieval frequency as the second interaction information.

In the practical use, the human interaction information may refer to a human-related feature, and the human interaction information generally changes over time. For example, when acquiring the flow frequency of human moving between the plurality of regions at the specified time and determining the flow frequency as the first interaction information, since different numbers of humans may move between the plurality of regions in different time periods, the flow frequency of human moving between the plurality of regions at the specified time may be acquired and determined as the human interaction information of the human interaction between the plurality of regions at the specified time. For example, at time t, if 13 humans in region A are going to region B, the flow frequency 13 may be used as the human interaction information. For another example, the retrieval frequency between the plurality of regions at the specified time may be acquired and used as the human interaction information. For example, at time t, 10 humans in region A are retrieving the environment of region B, 8 humans in region A are retrieving the fine food of region B, and 6 humans in region A are retrieving the educational information of region B, then the total number of retrievals 24 may be determined as the human interaction information. In the practical use, both the flow frequency of human moving between the plurality of regions at the specified time and the retrieval frequency between the plurality of regions at the specified time may be acquired, and the human interaction information may be obtained by performing a weighted summation on the flow frequency of human moving between the regions and the retrieval frequency between the regions using preset weights. For example, a weighted summation may be performed on the flow frequency 13 of the human moving between the plurality of regions at the specified time and the retrieval frequency 24 between the plurality of regions at the specified time by using the preset weights of 0.5 and 0.2, and the human interaction information 11.3 of the human interaction between the plurality of regions at the specified time may be obtained.

With the method of the embodiments of the present disclosure, the embedding representation vector may be calculated according to the flow frequency of human moving between the plurality of regions and/or the retrieval frequency between the plurality of regions, and the land usage property is calculated according to the embedding representation vector, so that the prediction may be performed according to the feature containing the human interaction information, which may improve the accuracy of prediction.

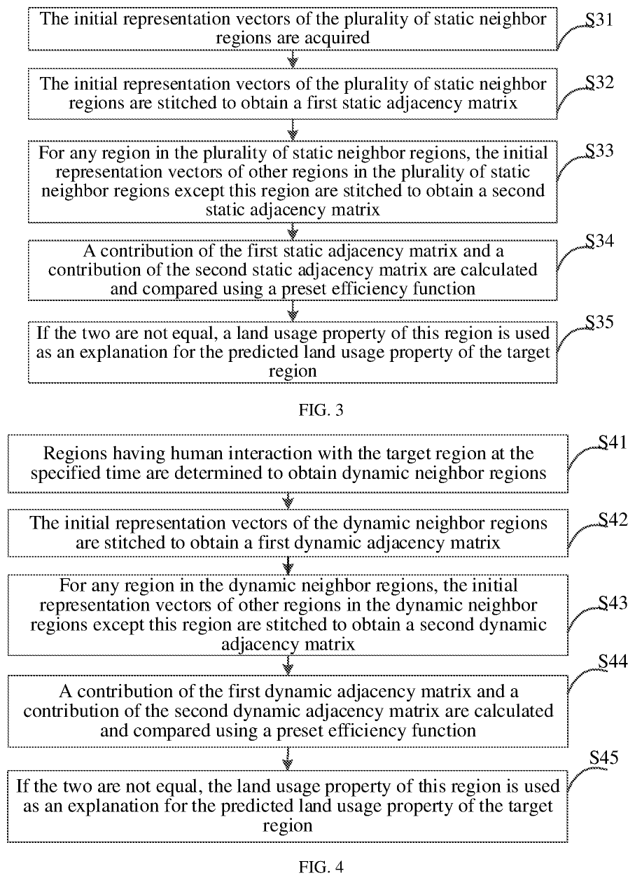

Optionally, referring to FIG. 3, the method further includes step S31 to step S35.

In step S31, the initial representation vectors of the plurality of static neighbor regions are acquired.

In step S32, the initial representation vectors of the plurality of static neighbor regions are stitched to obtain a first static adjacency matrix.

In step S33, for any region in the plurality of static neighbor regions, the initial representation vectors of other regions in the plurality of static neighbor regions except this region are stitched to obtain a second static adjacency matrix.

In step S34, a contribution of the first static adjacency matrix and a contribution of the second static adjacency matrix are calculated and compared using a preset efficiency function.

In step S35, if the two are not equal, a land usage property of this region is used as an explanation for the predicted land usage property of the target region.

In the present disclosure, since a process of analyzing the feature map by using the pre-trained graph convolution network to obtain the predicted land usage property of the target region at the next time is similar to a “black box”, in order to facilitate the understanding of the process of analyzing the feature map by using the pre-trained graph convolution network in the present disclosure, this process is explained in the present disclosure to meet a need of a service scenario in the practical use. For example, when the predicted land usage property of the target region is the commercial land, a cause of the prediction of the commercial land for the land usage property of the target region may be explained according to the land usage property of the static neighbor region. For example, when the land usage property of the static neighbor region of the target region is the commercial land, commerce may also be developed in the target region, which may result in the prediction of the commercial land for the land usage property of the target region.

When stitching the initial representation vectors of the plurality of static neighbor regions so as to obtain the static adjacency matrix, the initial representation vectors of the plurality of static neighbor regions may be arranged in a preset order to form the static adjacency matrix. For example, if N vectors are arranged from top to bottom, an N-row matrix may be formed. Specifically, one or more vectors may be filled with a preset value. When vector a of (1, 12, 31, 15, 5, 12) and vector b of (2, 10, 30, 5) are stitched to generate a matrix, the vector b may be filled to (2, 10, 30, 5, 0, 0) so that the vectors have the equal length. Then, a matrix with 2 rows and 6 columns may be generated according to the matrix.

The efficiency function in the present disclosure may be used to calculate an influence of the initial representation vector of each region of the plurality of static neighbor regions on the static adjacency matrix. Specifically, the efficiency function may be F(x) function. Specifically, in the present disclosure, for the initial representation vector of each region, an efficiency in a state where the initial representation vector of this region is contained in the static adjacency matrix and an efficiency in a state where the initial representation vector of this region is not contained in the static adjacency matrix may be calculated successively and compared using the efficiency function.

Specifically, the efficiency in the state where the initial representation vector of this region is contained in the static adjacency matrix and the efficiency in the state where the initial representation vector of this region is not contained in the static adjacency matrix may be calculated, and when the two are inconsistent, the land usage property of this region may be used as the explanation for the predicted land usage property of the target region. For example, when the predicted land usage property of the target region is the commercial land, the land usage property of the target region may be explained using the land usage property of the neighbor region. For example, through analysis, when the land usage properties of the neighbor regions are commercial lands, the land usage property of the target region at the next time may change to the commercial land.

Specifically, in step 1, a set S of static neighbor regions of the target region u is selected, and an adjacency matrix A is constructed according to an initial representation matrix of the static neighbor regions s. In step 2, ∀s∈S, let S′=S\s, A′=A(S′). For any neighbor region in the plurality of static neighbor regions, a set S′ of other regions in the plurality of neighbor regions except this region are selected, and a matrix A′ is generated according to the initial representation vectors of the regions in the set S′. In step 3, an efficiency M(u, S, A) in the state where the initial representation vector of this region is contained in the static adjacency matrix and an efficiency M(u, S′, A′) in the state where the initial representation vector of this region is not contained in the static adjacency matrix are calculated using a preset efficiency function M. If M(u, S, A)≠M(u, S′, A′), the land usage property of this region is used as the explanation for the land usage property of the target region. In step 4, if the efficiency M(u, S, A) in the state where the initial representation vector of this region is contained in the static adjacency matrix is equal to the efficiency M(u, S′, A′) in the state where the initial representation vector of this region is not contained in the static adjacency matrix, this region is discarded, then another region is selected from the set S of the static neighbor regions of the target region u, and the above step 2 and step 3 are repeatedly performed until all regions have been selected. The regions that may be used as the explanation for the land usage property of the target region may be combined to obtain a set E.

With the method of the embodiments of the present disclosure, the predicted land usage property of the target region may be explained with the feature of the neighbor region of the target region, which may facilitate the understanding of users and meet the need of the service scenario in the practical use.

Alternatively, referring to FIG. 4, the method further includes step S41 to step S45.

In step S41, regions having human interaction with the target region at the specified time are determined to obtain dynamic neighbor regions.

In step S42, the initial representation vectors of the dynamic neighbor regions are stitched to obtain a first dynamic adjacency matrix.

In step S43, for any region in the dynamic neighbor regions, the initial representation vectors of other regions in the dynamic neighbor regions except this region are stitched to obtain a second dynamic adjacency matrix.

In step S44, a contribution of the first dynamic adjacency matrix and a contribution of the second dynamic adjacency matrix are calculated and compared using a preset efficiency function.

In step S45, if the two are not equal, the land usage property of this region is used as an explanation for the predicted land usage property of the target region.

In the practical use, the region having human interaction with the target region at the specified time may also be used as the explanation for the predicted land usage property of the target region. A specific calculation method is similar to that in the above-described embodiment. For each region having human interaction with the target region at the specified time, the efficiency in a state where the initial representation vector of this region is contained in the dynamic adjacency matrix and the efficiency in a state where the initial representation vector of this region is not contained in the dynamic adjacency matrix may be calculated, and when the two are inconsistent, the land usage property of this region may be used as the explanation for the predicted land usage property of the target region.

With the method of the embodiments of the present disclosure, the predicted land usage property of the target region may be explained by the region having human interaction with the target region at the specified time, which may facilitate the understanding of users and meet the need of the service scenario in the practical use.

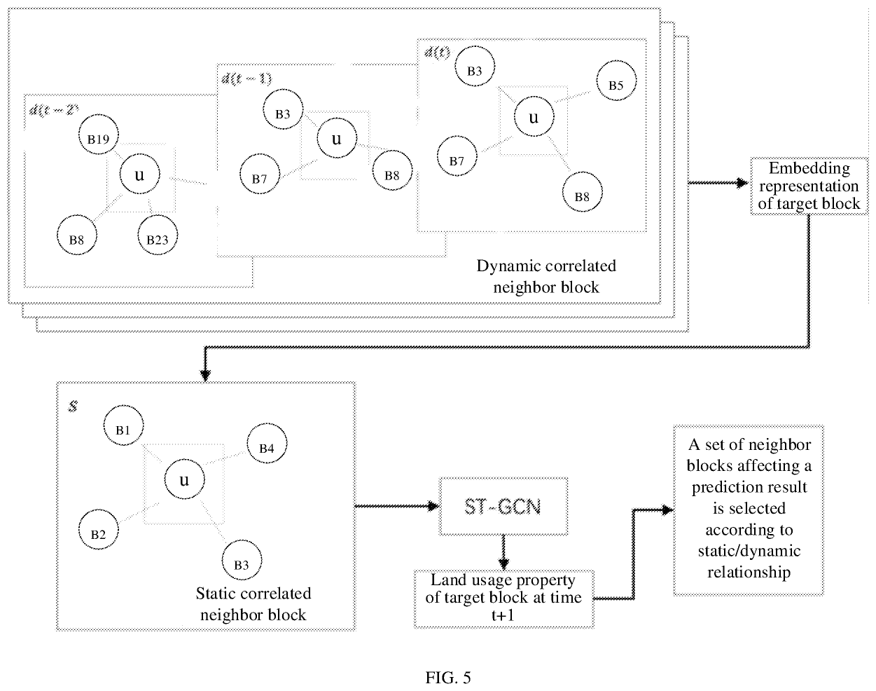

Alternatively, a method of predicting a regional land usage property change of the present disclosure may refer to FIG. 5, including the following steps. In step 1, a target city is divided into a plurality of regions according to the road network information. Here, the region is called block. In step 2, a land usage property weight distribution of each block is calculated according to the land usage property in the block, and a land with a highest land distribution weight in the block is selected as a representative land of the block. In step 3, regions correlated with the target region may be divided into a static correlated neighbor region and a dynamic correlated neighbor region. The static correlated neighbor region is a region correlated with u based on a distance relationship, and the dynamic correlated neighbor region is a region correlated with u based on a human movement trajectory. The distance relationship does not change with time, while the human movement behavior may change with time. In step 4, a sampling is performed on the neighbor regions of the target region, a dynamic relationship (such as user visit) at time t is selected, and the neighbor regions of the target region are determined as a neighbor node set. In step 5, a land distribution weight vector of the target region is determined as the initial representation vector of the target region, the embedding representation vector of the target region is calculated according to the dynamic relationship at time t, and the initial representation vector of the target region is updated. In step 6, the updated representation vector of the target region is determined as a node feature, and a random sampling is performed on the static correlated neighbor regions of the target region according to the static relationship, then a graph convolution operation is perform using ST-GCN (Spatial Temporal Graph Convolutional Neural Network) according to a sub-graph obtained after the sampling, and the land usage property at the next time is output.

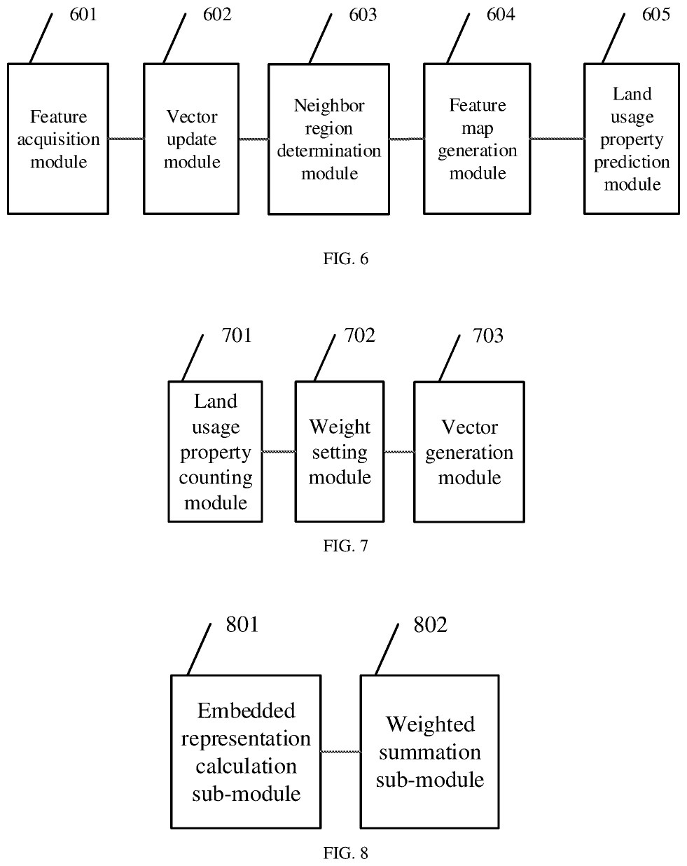

According to another aspect of the present disclosure, there is provided an apparatus of determining a regional land usage property. As shown in FIG. 6, the apparatus includes: a feature acquisition module 601 used to acquire a human interaction information between a plurality of regions at a specified time; a vector update module 602 used to update an initial representation vector of each region according to the human interaction information so as to obtain an embedding representation vector of each region, here, for any region, the initial representation vector of the region is calculated according to an initial land usage property of the region; a neighbor region determination module 603 used to select a target region from the regions and select a plurality of static neighbor regions within a preset range around the target region; a feature map generation module 604 used to generate a feature map of the target region according to the embedding representation vector of the target region and the embedding representation vectors of the plurality of static neighbor regions; and a land usage property prediction module 605 used to predict a land usage property of the target region by using the feature map, so as to obtain a predicted land usage property of the target region at a next time.

Optionally, as shown in FIG. 7, the apparatus further includes: a land usage property counting module 701 used to count an initial land usage property of each sub-region in any region; a weight setting module 702 used to obtain a weight for each sub-region in the region according to the initial land usage property of each sub-region in the region and a preset weight for a land usage property; and a vector generation module 703 used to generate the initial representation vector of the region according to the weight for each sub-region in the region.

Optionally, as shown in FIG. 8, the vector update module 602 includes: an embedding representation calculation sub-module 801 used to calculate a fusion feature vector of each region according to the human interaction information and the initial representation vector of each region; and a weighted summation sub-module 802 used to perform a weighted summation on the fusion feature vector of each region and the initial representation vector of each region according to a preset coefficient, so as to obtain the embedding representation vector of each region.

Optionally, the human interaction information includes a first interaction information and/or a second interaction information. The feature acquisition module 601 is specifically used to acquire a flow frequency of human moving between the plurality of regions at the specified time and determine the flow frequency as the first interaction information; and/or acquire a region retrieval frequency of human between the plurality of regions at the specified time and determine the region retrieval frequency as the second interaction information.

Optionally, the neighbor region determination module 603 is specifically used to select a region to be predicted for the land usage property from the regions, so as to obtain the target region; and select a plurality of random regions within the preset range around the target region, so as to obtain the plurality of static neighbor regions.

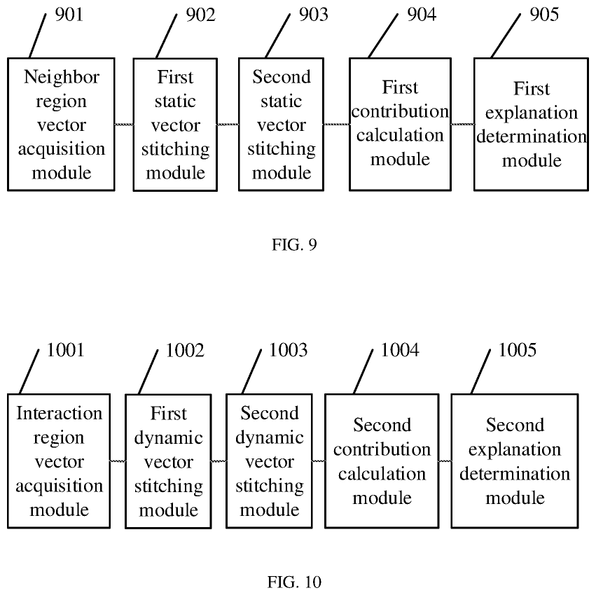

Optionally, as shown in FIG. 9, the apparatus further includes: a neighbor region vector acquisition module 901 used to acquire initial representation vectors of a plurality of static neighbor regions; a first static vector stitching module 902 used to stitch the initial representation vectors of the plurality of static neighbor regions, so as to obtain a first static adjacency matrix; a second static vector stitching module 903 used to stitch, for any region in the plurality of static neighbor regions, the initial representation vectors of other regions in the plurality of static neighbor regions except this region, so as to obtain a second static adjacency matrix; a first contribution calculation module 904 used to calculate and compare a contribution of the first static adjacency matrix and a contribution of the second static adjacency matrix using a preset efficiency function; and a first explanation determination module 905 used to determine the land usage property of this region as an explanation for the predicted land usage property of the target region in response to the contribution of the first static adjacency matrix being not equal to the contribution of the second static adjacency matrix.

Optionally, as shown in FIG. 10, the apparatus further includes: an interaction region vector acquisition module 1001 used to determine regions having a human interaction with the target region at the specified time, so as obtain dynamic neighbor regions; a first dynamic vector stitching module 1002 used to stitch the initial representation vectors of the dynamic neighbor regions, so as to obtain a first dynamic adjacency matrix; a second dynamic vector stitching module 1003 used to stitch, for any region in the plurality of dynamic neighbor regions, the initial representation vectors of other regions in the plurality of dynamic neighbor regions except this region, so as to obtain a second dynamic adjacency matrix; a second contribution calculation module 1004 used to calculate and compare a contribution of the first dynamic adjacency matrix and a contribution of the second dynamic adjacency matrix using a preset efficiency function; and a second explanation determination module 1005 used to calculate and compare a contribution of the first dynamic adjacency matrix and a contribution of the second dynamic adjacency matrix using a preset efficiency function.

Optionally, the land usage property prediction module 605 is specifically used to analyze the feature sub-map by using the pre-trained graph convolution network, so as to obtain the predicted land usage property of the target block at the next time. The pre-trained graph convolution network is a network model trained using a historical land usage property.

With the apparatus of the embodiments of the present disclosure, the embedding representation vector is set according to the land usage property of the region, then the embedding representation vector of the target region and the embedding representation vectors of the plurality of static neighbor regions are used to generate the feature sub-map, and finally the feature map is used to predict the land usage property of the target region so as to obtain the predicted land usage property of the target region at the next time. Not only the regional land usage property may be predicted, but also the predicted regional land usage property may provide reference for urban planning.

In the technical solution of the present disclosure, an acquisition, storage, use, processing, transmission, provision, disclosure and application of the user's personal information involved are in compliance with the provisions of relevant laws and regulations, take essential confidentiality measures, and do not violate public order and good customs.

In the technical solution of the present disclosure, authorization or consent is obtained from the user before the user's personal information is obtained or collected.

According to the embodiments of the present disclosure, the present disclosure further provides an electronic device, a readable storage medium, and a computer program product.

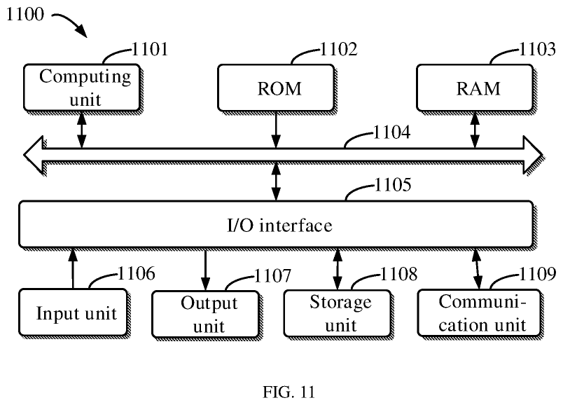

FIG. 11 shows a schematic block diagram of an exemplary electronic device 1100 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 11, the device 1100 may include a computing unit 1101, which may perform various appropriate actions and processing based on a computer program stored in a read-only memory (ROM) 1102 or a computer program loaded from a storage unit 1108 into a random access memory (RAM) 1103. Various programs and data required for the operation of the device 1100 may be stored in the RAM 1103. The computing unit 1101, the ROM 1102 and the RAM 1103 are connected to each other through a bus 1104. An input/output (I/O) interface 1105 is further connected to the bus 1104.

Various components in the device 1100, including an input unit 1106 such as a keyboard, a mouse, etc., an output unit 1107 such as various types of displays, speakers, etc., a storage unit 1108 such as a magnetic disk, an optical disk, etc., and a communication unit 1109 such as a network card, a modem, a wireless communication transceiver, etc., are connected to the I/O interface 1105. The communication unit 1109 allows the device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 1101 may perform the various methods and processes described above, such as the method of determining the regional land usage property. For example, in some embodiments, the method of determining the regional land usage property may be implemented as a computer software program that is tangibly contained on a machine-readable medium, such as the storage unit 1108. In some embodiments, part or all of a computer program may be loaded and/or installed on the device 1100 via the ROM 1102 and/or the communication unit 1109. When the computer program is loaded into the RAM 1103 and executed by the computing unit 1101, one or more steps of the method of determining the regional land usage property described above may be performed. Alternatively, in other embodiments, the computing unit 1101 may be configured to perform the method of determining the regional land usage property in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local region network (LAN), a wide region network (WAN), and Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a blockchain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of determining a regional land usage property, the method comprising:
acquiring a human interaction information between a plurality of regions at a specified time;
updating an initial representation vector of each of the regions according to the human interaction information, so as to obtain an embedding representation vector of each of the regions, wherein for each region, the initial representation vector of the region is calculated according to an initial land usage property of the region;
selecting a target region from the regions, and selecting a plurality of static neighbor regions within a preset range around the target region;
generating a feature map of the target region according to the embedding representation vector of the target region and the embedding representation vectors of the plurality of static neighbor regions; and
predicting a land usage property of the target region by using the feature map, so as to obtain a predicted land usage property of the target region at a next time.

2. The method of claim 1, comprising: before updating the initial representation vector of each of the regions according to the human interaction information, so as to obtain the embedding representation vector of each of the regions,
counting, for any region, an initial land usage property of each sub-region in the region;
determining a weight for each sub-region in the region according to the initial land usage property of each sub-region in the region and a preset weight for the land usage property; and
generating the initial representation vector of the region according to the weight for each sub-region in the region.

3. The method of claim 1, wherein the updating an initial representation vector of each of the regions according to the human interaction information, so as to obtain an embedding representation vector of each of the regions comprises:
calculating a fusion feature vector of each of the regions according to the human interaction information and the initial representation vector of each of the regions; and
performing a weighted summation on the fusion feature vector of each of the regions and the initial representation vector of each of the regions according to a preset coefficient, so as to obtain the embedding representation vector of each of the regions.

4. The method of claim 1, wherein the human interaction information comprises a first interaction information and/or a second interaction information, and the acquiring a human interaction information between a plurality of regions at a specified time comprises:
acquiring a flow frequency of human moving between the plurality of regions at the specified time, and determining the flow frequency as the first interaction information; and/or
acquiring a region retrieval frequency of human between the plurality of regions at the specified time, and determining the region retrieval frequency as the second interaction information.

5. The method of claim 1, wherein the selecting a target region from the regions, and selecting a plurality of static neighbor regions within a preset range around the target region comprises:
selecting a region to be predicted for a land usage property from the regions, so as to obtain the target region; and
selecting a plurality of random regions within the preset range around the target region, so as to obtain the plurality of static neighbor regions.

6. The method of claim 1, further comprising:
acquiring initial representation vectors of the plurality of static neighbor regions;
stitching the initial representation vectors of the plurality of static neighbor regions, so as to obtain a first static adjacency matrix;
for any region in the plurality of static neighbor regions, stitching the initial representation vectors of other regions in the plurality of static neighbor regions except the region, so as to obtain a second static adjacency matrix;
calculating and comparing a contribution of the first static adjacency matrix and a contribution of the second static adjacency matrix by using a preset efficiency function; and
determining a land usage property of the region as an explanation for the predicted land usage property of the target region, in response to the contribution of the first static adjacency matrix being not equal to the contribution of the second static adjacency matrix.

7. The method of claim 1, further comprising:
determining regions with a human interaction with the target region at the specified time, so as to obtain dynamic neighbor regions;
stitching the initial representation vectors of the dynamic neighbor regions, so as to obtain a first dynamic adjacency matrix;
for any region in the dynamic neighbor regions, stitching the initial representation vectors of other regions in the dynamic neighbor regions except the region, so as to obtain a second dynamic adjacency matrix;
calculating and comparing a contribution of the first dynamic adjacency matrix and a contribution of the second dynamic adjacency matrix by using a preset efficiency function; and
determining a land usage property of the region as an explanation for the predicted land usage property of the target region, in response to the contribution of the first dynamic adjacency matrix being not equal to the contribution of the second dynamic adjacency matrix.

8. The method of claim 1, wherein the predicting a land usage property of the target region by using the feature map, so as to obtain a predicted land usage property of the target region at a next time comprise analyzing the feature sub-map by using a pre-trained graph convolution network, so as to obtain the predicted land usage property of the target block at the next time, wherein the pre-trained graph convolution network is a network model trained using a historical land usage property.

9. The method of claim 2, comprising: before updating the initial representation vector of each of the regions according to the human interaction information, so as to obtain the embedding representation vector of each of the regions,
counting, for any region, an initial land usage property of each sub-region in the region;
determining a weight for each sub-region in the region according to the initial land usage property of each sub-region in the region and a preset weight for the land usage property; and
generating the initial representation vector of the region according to the weight for each sub-region in the region.

10. The method of claim 2, wherein the updating an initial representation vector of each of the regions according to the human interaction information, so as to obtain an embedding representation vector of each of the regions comprises:
calculating a fusion feature vector of each of the regions according to the human interaction information and the initial representation vector of each of the regions; and
performing a weighted summation on the fusion feature vector of each of the regions and the initial representation vector of each of the regions according to a preset coefficient, so as to obtain the embedding representation vector of each of the regions.

11. An electronic device, comprising:
at least one processor; and
a memory communicatively connected to the at least one processor, wherein the memory stores instructions executable by the at least one processor, and the instructions, when executed by the at least one processor, cause the at least one processor to at least:
acquire a human interaction information between a plurality of regions at a specified time;
update an initial representation vector of each of the regions according to the human interaction information, so as to obtain an embedding representation vector of each of the regions, wherein for each region, the initial representation vector of the region is calculated according to an initial land usage property of the region;
select a target region from the regions, and select a plurality of static neighbor regions within a preset range around the target region;
generate a feature map of the target region according to the embedding representation vector of the target region and the embedding representation vectors of the plurality of static neighbor regions; and
predict a land usage property of the target region by using the feature map, so as to obtain a predicted land usage property of the target region at a next time.

12. The electronic device of claim 11, wherein the instructions, when executed by the at least one processor, are further configured to cause the at least one processor to: before update of the initial representation vector of each of the regions according to the human interaction information, so as to obtain the embedding representation vector of each of the regions,
count, for any region, an initial land usage property of each sub-region in the region;
determine a weight for each sub-region in the region according to the initial land usage property of each sub-region in the region and a preset weight for the land usage property; and
generate the initial representation vector of the region according to the weight for each sub-region in the region.

13. The electronic device of claim 11, wherein the instructions, when executed by the at least one processor, are further configured to cause the at least one processor to:
calculate a fusion feature vector of each of the regions according to the human interaction information and the initial representation vector of each of the regions; and
perform a weighted summation on the fusion feature vector of each of the regions and the initial representation vector of each of the regions according to a preset coefficient, so as to obtain the embedding representation vector of each of the regions.

14. The electronic device of claim 11, wherein the human interaction information comprises a first interaction information and/or a second interaction information, and the instructions, when executed by the at least one processor, are further configured to cause the at least one processor to:
acquire a flow frequency of human moving between the plurality of regions at the specified time, and determine the flow frequency as the first interaction information; and/or
acquire a region retrieval frequency of human between the plurality of regions at the specified time, and determine the region retrieval frequency as the second interaction information.

15. The electronic device of claim 11, wherein the instructions, when executed by the at least one processor, are further configured to cause the at least one processor to:
select a region to be predicted for a land usage property from the regions, so as to obtain the target region; and
select a plurality of random regions within the preset range around the target region, so as to obtain the plurality of static neighbor regions.

16. The electronic device of claim 11, wherein the instructions, when executed by the at least one processor, are further configured to cause the at least one processor to:
acquire initial representation vectors of the plurality of static neighbor regions;
stitch the initial representation vectors of the plurality of static neighbor regions, so as to obtain a first static adjacency matrix;
for any region in the plurality of static neighbor regions, stitch the initial representation vectors of other regions in the plurality of static neighbor regions except the region, so as to obtain a second static adjacency matrix;
calculate and compare a contribution of the first static adjacency matrix and a contribution of the second static adjacency matrix by using a preset efficiency function; and
determine a land usage property of the region as an explanation for the predicted land usage property of the target region, in response to the contribution of the first static adjacency matrix being not equal to the contribution of the second static adjacency matrix.

17. The electronic device of claim 11, wherein the instructions, when executed by the at least one processor, are further configured to cause the at least one processor to:
determine regions with a human interaction with the target region at the specified time, so as to obtain dynamic neighbor regions;
stitch the initial representation vectors of the dynamic neighbor regions, so as to obtain a first dynamic adjacency matrix;
for any region in the dynamic neighbor regions, stitch the initial representation vectors of other regions in the dynamic neighbor regions except the region, so as to obtain a second dynamic adjacency matrix;
calculate and compare a contribution of the first dynamic adjacency matrix and a contribution of the second dynamic adjacency matrix by using a preset efficiency function; and
determine a land usage property of the region as an explanation for the predicted land usage property of the target region, in response to the contribution of the first dynamic adjacency matrix being not equal to the contribution of the second dynamic adjacency matrix.

18. The electronic device of claim 11, wherein the instructions, when executed by the at least one processor, are further configured to cause the at least one processor to analyze the feature sub-map by using a pre-trained graph convolution network, so as to obtain the predicted land usage property of the target block at the next time, wherein the pre-trained graph convolution network is a network model trained using a historical land usage property.

19. The electronic device of claim 12, wherein the instructions, when executed by the at least one processor, are further configured to cause the at least one processor to: before update of the initial representation vector of each of the regions according to the human interaction information, so as to obtain the embedding representation vector of each of the regions,
count, for any region, an initial land usage property of each sub-region in the region;
determine a weight for each sub-region in the region according to the initial land usage property of each sub-region in the region and a preset weight for the land usage property; and
generate the initial representation vector of the region according to the weight for each sub-region in the region.

20. A non-transitory computer-readable storage medium having computer instructions stored therein, the instructions, when executed by a computer system, configured to cause the computer system to at least:
acquire a human interaction information between a plurality of regions at a specified time;
update an initial representation vector of each of the regions according to the human interaction information, so as to obtain an embedding representation vector of each of the regions, wherein for each region, the initial representation vector of the region is calculated according to an initial land usage property of the region;
select a target region from the regions, and select a plurality of static neighbor regions within a preset range around the target region;
generate a feature map of the target region according to the embedding representation vector of the target region and the embedding representation vectors of the plurality of static neighbor regions; and
predict a land usage property of the target region by using the feature map, so as to obtain a predicted land usage property of the target region at a next time.
